(19) United States
(12) Patent Application Publication
(10) Pub. No.: US 2018/0290497 A1
(43) Pub. Date: Oct. 11, 2018

(54) VEHICLE TIRE

(71) Applicant: Super ATV, LLC, Madison, IN (US)

(72) Inventors: Dennis R. Franklin, Yuma, AZ (US); Dennis Kent, Madison, IN (US)

(73) Assignee: Super ATV, LLC, Madison, IN (US)

(21) Appl. No.: 15/949,128

(22) Filed: Apr. 10, 2018

Related U.S. Application Data
(60) Provisional application No. 62/484,083, filed on Apr. 11, 2017.

(51) Int. Cl. B60C 11/03; B60C 9/20

(52) U.S. Cl. CPC B60C 11/0311; B60C 11/0304; B60C 2200/14; B60C 9/2003; B60C 2011/0313; B60C 9/20

(57) ABSTRACT

A vehicle tire includes tread blocks with a substantially-horizontal upper/top surface, a first pair of downward-sloping surfaces, a pair of horizontal shoulder surfaces, and a second pair of downward-sloping surfaces. The first pair of downward-sloping surfaces begins and slopes downward and outward from the upper/top surface. Each of the horizontal shoulder surfaces begins and extends outward from one of said first pair of downward-sloping surfaces. The second pair of downward-sloping surfaces begins and slopes downward and outward from the horizontal shoulder surfaces.

### CROSS-REFERENCE TO RELATED APPLICATIONS

This application claims priority from U.S. Provisional Patent Application Ser. No. 62/484,083, filed Apr. 11, 2017. The entire contents of all related applications are hereby incorporated herein by reference.

### FIELD OF THE INVENTION

The present invention relates generally to vehicle tires, and more particularly to tires effective for use on an all-terrain vehicle (ATV) or a utility task vehicle (UTV).

### BACKGROUND TO THE INVENTION

Off-road vehicles such as ATVs and UTVs need tires that provide superior off-road performance since that is where the majority of the riding is done. Current ATV and UTV tires therefore typically have open tread patterns to provide good traction in mud, sand, or rocks, where the characteristics of conformability, flexibility and traction are essential design targets. In addition, puncture resistance is important for off-road use, where puncture hazards are more frequently encountered.

ATVs and UTVs are increasingly used on paved roads however, and even on highways—where DOT certification requirements must be satisfied. On-road properties such as directional stability, steering response, and a smooth ride are therefore important design characteristics for modern ATV and UTV tires, and must accordingly be balanced with the traction and puncture resistance characteristics that remain a central focus.

As the ATV and UTV market continues to evolve with bigger and more powerful models, tire designs must be improved to handle such high horse power and lateral loads. Additionally, environmental concerns must be addressed to balance the needs of the consumer with the environmental impact.

A need therefore exists for tires that provide superior on-road and off-road performance, including superior traction and puncture resistance, with improved directional stability and steering response. The present invention addresses those needs.

### SUMMARY OF THE INVENTION

One aspect of the present invention provides a vehicle tire having tread blocks comprising a substantially-horizontal upper/top surface, a first pair of downward-sloping surfaces, a pair of horizontal shoulder surfaces, and a second pair of downward-sloping surfaces. The first pair of downward-sloping surfaces begins at and slopes downward and outward from the upper/top surface. Each of the horizontal shoulder surfaces begins at and extends outward from one of said first pair of downward-sloping surfaces. The second pair of downward-sloping surfaces begins at and slopes downward and outward from the horizontal shoulder surfaces.

One embodiment of the inventive vehicle tire comprises:
a) a first/lower body ply;
b) a first stabilizing belt directly overlaying the first/lower body ply and having cords running in a first direction;
c) a second/upper stabilizing belt overlaying the first stabilizing belt and having cords running in a second direction that is different from the direction of the first stabilizing belt;
d) a second/upper body ply; and
e) an outer tread layer;

wherein said outer tread layer comprises a multiplicity of tread blocks providing a tread pattern, wherein said multiplicity of tread blocks comprises a multiplicity of first central tread blocks, and a multiplicity of sidewall tread blocks; and

wherein each of said first central tread blocks comprises:
a) a substantially-horizontal upper/top surface;
b) a first pair of downward-sloping surfaces sloping downward and outward from the upper/top surface;
c) a pair of horizontal shoulder surfaces, wherein each of said pair of horizontal shoulder surfaces extends outward from one of said first pair of downward-sloping surfaces, and
d) a second pair of downward-sloping surfaces sloping downward and outward from the horizontal shoulder surfaces.

The first/lower body ply may have a radial ply construction or a bias ply construction, or any variation thereof. Similarly, the second body ply may have a radial ply construction or a bias ply construction, or any variation thereof.

The first stabilizing belt may comprise a network of natural or artificial fibers, and may particularly comprise a para-aramid synthetic fiber such as Kevlar®. Similarly, the second stabilizing belt may comprise a network of natural or artificial fibers, and may particularly comprise a para-aramid synthetic fiber such as Kevlar®.

In one aspect of the present invention there is provided a tire as described above wherein the first/lower body ply comprises a double-wrapped halobutyl inner liner.

In one aspect of the present invention there is provided a tire as described above wherein at least some of said tread blocks have one or more scalloped surfaces.

In one aspect of the present invention there is provided a tire as described above wherein at least some of said tread blocks have Z-shaped grooves or sipings.

In one aspect of the present invention there is provided a tire as described above wherein at least some of said tread blocks have mud release ribs.

In one aspect of the present invention there is provided a tire as described above wherein at least some of said tread blocks have sidewall deflection ribs.

In one aspect of the present invention there is provided a tire as described above wherein at least some of said tread blocks are positioned such that there is a 20-25° angle between the leading, and preferably also the trailing, edge of the tread bloc and a line perpendicular to the direction of roll.

### DESCRIPTION OF THE DRAWINGS

FIG. 1 shows a section view of a vehicle tire according to one embodiment of the present invention.

FIG. 2 shows a section view of a vehicle tire according to a second embodiment of the present invention.

FIG. 3 shows a section view of a tire tread block that may be used on a vehicle tire according to one embodiment of the present invention.

FIG. 4 shows a perspective view of a vehicle tire according to one embodiment of the present invention.

FIG. 5 shows a front view of a vehicle tire according to one embodiment of the present invention.

FIG. 6 shows a side view of a vehicle tire according to one embodiment of the present invention.

FIG. 7 shows a perspective view of the sidewall blocks that may be used on a vehicle tire according to one embodiment of the present invention.

FIG. 8 shows a perspective view of a sidewall block that may be used on a vehicle tire according to one embodiment of the present invention.

FIG. 9 shows a perspective view of a sidewall block that may be used on a vehicle tire according to one embodiment of the present invention.

FIG. 10 shows a perspective view of a tread block that may be used on a vehicle tire according to one embodiment of the present invention.

FIG. 11 shows a perspective view of a tread block that may be used on a vehicle tire according to one embodiment of the present invention.

### DESCRIPTION OF THE PREFERRED EMBODIMENTS

For the purposes of promoting an understanding of the principles of the invention, reference will now be made to certain embodiments and specific language will be used to describe the same. It will nevertheless be understood that no limitation of the scope of the invention is thereby intended, with such alterations and modifications to the illustrated device being contemplated as would normally occur to one skilled in the art to which the invention relates.

The present invention relates specifically to pneumatic tires for use on vehicles such as, but not limited to, all-terrain vehicles (ATVs) and utility task vehicles (UTVs). Such tires typically are mounted on a rim, and may include a bead, a sidewall, an inner liner, one or more body plies, one or more belts, a cap ply, and a tread.

As previously indicated, one aspect of the present invention provides a vehicle tire, comprising:
a) a first/lower body ply;
b) a first stabilizing belt directly overlaying the first/lower body ply and having cords running in a first direction;
c) a second/upper stabilizing belt overlaying the first stabilizing belt and having cords running in a second direction that is different from the direction of the first stabilizing belt;
d) a second/upper body ply; and
e) an outer tread layer;

wherein said outer tread layer comprises a multiplicity of tread blocks providing a tread pattern, wherein said multiplicity of tread blocks comprises a multiplicity of first central tread blocks, and a multiplicity of sidewall tread blocks; and

wherein each of said first central tread blocks comprises:
a) a substantially-horizontal upper/top surface;
b) a first pair of downward-sloping surfaces sloping downward and outward from the upper/top surface;
c) a pair of horizontal shoulder surfaces, wherein each of said pair of horizontal shoulder surfaces extends outward from one of said first pair of downward-sloping surfaces, and
d) a second pair of downward-sloping surfaces sloping downward and outward from the horizontal shoulder surfaces.

Any or all of the body plies may be made of a rubber or a rubber-coated synthetic material, and may be of a radial or bias construction, or any variation thereof. In one preferred embodiment the body plies are all radial body plies.

In some preferred embodiments two bias plies maybe encapsulated with one radial ply comprised of a tire cord, nylon or other synthetic material.

Any or all of the stabilizing belts may be made of a fabric material, and may comprise a network of natural or artificial fibers. The preferred stabilizing belts comprise a para-aramid synthetic fiber such as Kevlar®.

The stabilizing belts may be provided in either a radial- or bias-belted construction. In one preferred embodiment the first stabilizing belt is provided as a bias-belted construction, and the second stabilizing belt is provided as another bias-belted construction, with the cords of the first stabilizing belt lying at a 90° angle with respect to the cords of the second stabilizing belt.

The first (lower) stabilizing belt may directly overlay the first (lower) body ply, and the second body ply may directly overlay the first stabilizing belt. Accordingly, the first stabilizing belt may be “sandwiched” between the two body plies. Similarly, a second stabilizing belt may directly overlay the second body ply, and a third body ply may directly overlay the second stabilizing belt, thus “sandwiching” the second stabilizing belt between the two body plies.

The belt sandwiching described above allows for a belt package that controls casing distortion more efficiently during hard transitional changes. Providing more contact surface between the stabilizing belts and the casing body plies allows belt compression and or distortion to be controlled by the body plies and bead components. One benefit of the present invention is therefore a very light weight belt package that controls “slip angle” more efficiently than conventional processes, while allowing for a high degree of flexibility and conformability.

Additionally, as casing distortion is more controlled, decreased rolling resistance and increased fuel economy may be experienced. Increased steering feel and/or steering response may also result, making for a more responsive and controlled vehicle.

It is to be appreciated that the vehicle tires of the present invention are designed to be more flexible in the tread area without sacrificing too much lateral stability and compression control. This is particularly necessary and useful in smaller tire sizes.

In one preferred embodiment the tire comprises polyester corded rubberized polyester fabric radial body plies sandwiching Kevlar® corded rubberized bias ply belts. This provides a multi-angled puncture protection (MAPP) system that provides optimal strength and flexibility properties and improves the overall performance of the tire casing and sidewall.

In other embodiments vehicle tire, comprises:
a) a first/lower body ply;
b) a first stabilizing belt directly overlaying the first/lower body ply and having cords running in a first direction;
c) a second body ply directly overlaying the stabilizing belt, and thus “sandwiching” the stabilizing belt between the first and second body plies;
d) a second/upper stabilizing belt directly overlaying the second body ply and having cords running in a second direction that is different from the direction of the first stabilizing belt; and
e) an outer tread layer.

The first/lower body ply may have a radial ply construction or a bias ply construction, or any variation thereof. Similarly, the second body ply may have a radial ply construction or a bias ply construction, or any variation thereof.

The first stabilizing belt may comprise a network of natural or artificial fibers, and may particularly comprise a para-aramid synthetic fiber such as Kevlar®. Similarly, the second stabilizing belt may comprise a network of natural or artificial fibers, and may particularly comprise a para-aramid synthetic fiber such as Kevlar®.

In another aspect of the present invention there is provided a vehicle tire comprising:
a) a first/lower body ply;
b) a first stabilizing belt directly overlaying the first/lower body ply and having cords running in a first direction;
c) a second body ply directly overlaying the stabilizing belt, and thus “sandwiching” the stabilizing belt between the first and second body plies;
d) a second/upper stabilizing belt directly overlaying the second body ply and having cords running in a second direction that is different from the direction of the first stabilizing belt;
e) a third body ply directly overlaying the second/upper stabilizing belt; and
f) an outer tread layer.

As with the first aspect of the invention, any or all of the body plies of this embodiment may have a radial ply construction or a bias ply construction, or any variation thereof. Similarly, any or all of the stabilizing belts of this embodiment may comprise a network of natural or artificial fibers, and may particularly comprise a para-aramid synthetic fiber such as Kevlar®.

Accordingly, in another embodiment of the present invention there is provided a vehicle tire comprising:
a) a first/lower body ply;
b) a first and second belt package directly overlaying the first/lower body ply and having cords running in opposing directions; and
c) a second body ply directly overlaying the stabilizing belt package and having cords running in a first direction.

The inventive vehicle tire also includes a tread portion comprising a multiplicity of tread blocks. Preferably, both central tread blocks and sidewall tread blocks are included. In the most preferred embodiments two shapes of central tread blocks (namely, first central tread blocks and second central tread blocks) and two shapes of sidewall tread blocks (namely, first sidewall tread blocks and second sidewall tread blocks) are used.

Each of the central tread blocks of the present invention may include a substantially-horizontal upper/top surface, a first pair of downward-sloping surfaces sloping downward and outward from the upper/top surface, a pair of horizontal shoulder surfaces, and a second pair of downward-sloping surfaces sloping downward and outward from the horizontal shoulder surfaces. Any of all of the surfaces may be scalloped, with the leading and/or trailing edges most commonly being scalloped. Similarly, any or all of the top surfaces may be siped, with “Z”-shaped siping being most preferred. Additionally, at least some of the tread blocks may have mud release ribs, and at least some of the tread blocks have sidewall deflection ribs. The sidewall deflection ribs add puncture protection and thickness/strength to the sidewall where the body ply turn ups meet, while maintaining needed sidewall flexibility.

At least some of the central tread blocks may be positioned such that there is a 20-25° angle between the leading, and preferably also the trailing, edge of the tread bloc and a line perpendicular to the direction of roll. The most preferred angle for the central tread blocks is approximately 23° when measured between the leading, and preferably also the trailing, edge of the tread bloc and a line perpendicular to the direction of roll.

The staggered and tapered tread design provides good forward and lateral bite for an all-terrain tire. The sidewall tread blocks provide additional strength and flexibility where the sidewall meets the traction patch of the tire.

Proper tire profile allows the components of this vehicle tire to operate properly on the intended vehicle. In particular, a dual tread arch is provided to allow the casing and tread elements to provide their intended results. The center of the tread, typically providing about 50% of the tread's total surface, is almost totally flat with and extremely shallow tread arch. The remaining shoulder portions are tapered to the outside at an angle determined by size and casing construction, which is preferably between 5 and 10 degrees from the center of tread. The outer edges of the tread blend into the sidewalls, providing a very rounded profile. This allows a very smooth transition of traction under extremely hard maneuvers minimizing hard breakaway and or grabbing tendencies on high profile vehicles.

Sidewall profile is determined by tire bulge on measuring rim at recommended air pressure with operating weight. This method of casing profile determination reduces tension on sidewall rubber greatly enhancing sidewall puncture resistance. Also, when coupled with a stiff progressive bead package, the tire construction will allow for very predictable vehicle control in all conditions.

The bead package preferably comprises a maximum-allowable high tension wire bundle with a very thick long high modules rubber bead filler with two progressively spaced body ply turn-ups.

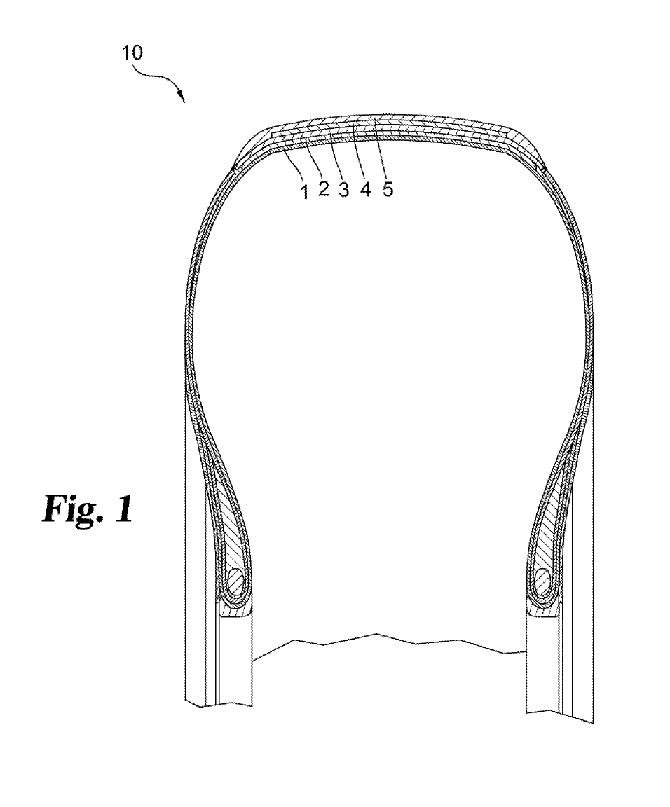

Referring now to the drawings, FIG. 1 shows a section view of a vehicle tire according to one embodiment of the present invention. Tire 10 comprises a first (lower) body ply 1; a first stabilizing belt 2 directly overlaying the first body ply and having cords running in a first direction; a second body ply 3 directly overlaying the stabilizing belt, and thus “sandwiching” the stabilizing belt between the first and second body plies; a second stabilizing belt 4 directly overlaying the second body ply and having cords running in a second direction that is different from the direction of the first stabilizing belt; and an outer tread layer 5 overlaying the second, upper stabilizing belt. Other features that are conventional to pneumatic tires, such as the beads, sidewalls, etc., are also shown.

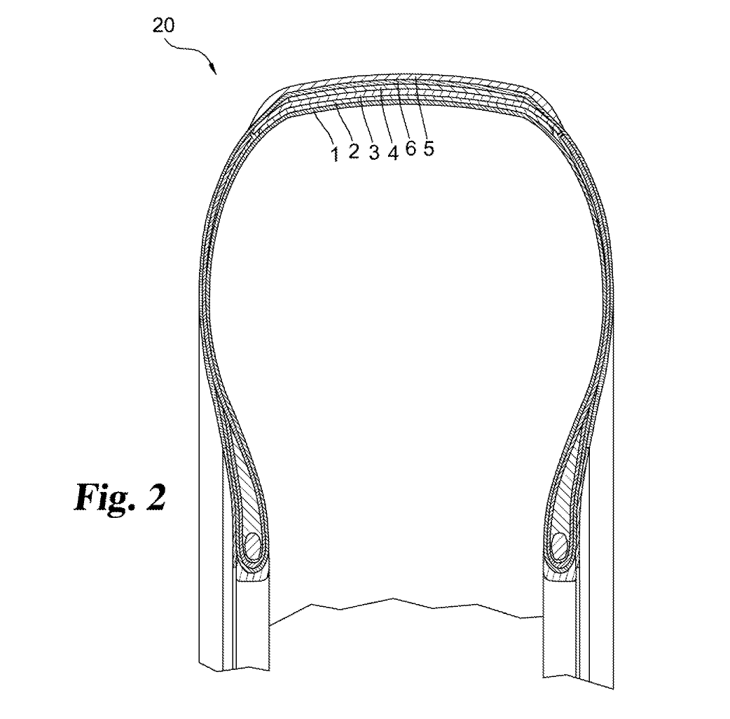

FIG. 2 shows a section view of a vehicle tire according to a second embodiment of the present invention. Tire 20 comprises a first (lower) body ply 1; a first stabilizing belt 2 directly overlaying the first body ply and having cords running in a first direction; a second body ply 3 directly overlaying the stabilizing belt, and thus “sandwiching” the stabilizing belt between the first and second body plies; a second stabilizing belt 4 directly overlaying the second body ply and having cords running in a second direction that is different from the direction of the first stabilizing belt; a third body ply 6 directly overlaying the first stabilizing belt, and thus “sandwiching” the second stabilizing belt between the second and third body plies; and an outer tread layer 5 overlaying the second, upper stabilizing belt. Here too, other features that are conventional to pneumatic tires, such as the beads, sidewalls, etc., are also shown.

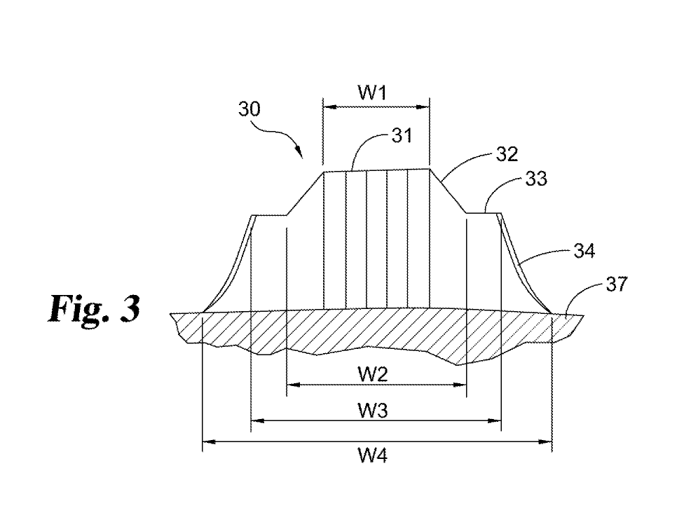

FIG. 3 shows a section view of a tire tread block that may be used on a vehicle tire according to one embodiment of the present invention. Tire block 30 comprises a substantially-horizontal upper/top surface 31, a first pair of downward-sloping surfaces 32, a pair of horizontal shoulder surfaces 33, and a second pair of downward-sloping surfaces 34. The first pair of downward-sloping surfaces 32 begins and slopes downward and outward from the upper/top surface 31. Each of the horizontal shoulder surfaces 33 begins and extends outward from one of said first pair of downward-sloping surfaces 32. The second pair of downward-sloping surfaces 34 begins and slopes downward and outward from the horizontal shoulder surfaces 33.

Tire block 30 can thus be seen to provide portions of different, and increasingly wider, widths as one moves downward from the top surface of the block. For example, upper/top surface 31 has a first width W1. A second portion comprising the portion of the tire block above horizontal shoulder surfaces 33 has a second width W2 that is greater than first width W1. A third portion comprising the portion of the tire block that includes horizontal shoulder surfaces 33 has a third width W3 that is greater than second width W2. And a fourth portion of the tire block that includes the second pair of downward-sloping surfaces 34 sloping downward and outward from horizontal shoulder surfaces 33 has a fourth width W4 that is greater than third width W3.

It can be seen that the two “sides” of the tire block section shown in FIG. 3 are free from any “vertical” surfaces (i.e., free from surfaces that are at a 90° angle with respect to the base of the tire block). Surfaces 31 and 33 are parallel to the base of the tire block, and surfaces 32 and 34 are angles at an angle of less than 90° with respect to the base of the tire block.

Additionally, W1, and upper/top surface 31 may be of any width specified by design characteristics, tire size and element placement on tire casing. Similarly, downward-sloping surfaces 32 may taper or have a vertical angle that may vary from less than 5° (as low as 1°) to 25°. W2 is generally determined by element placement on the casing—as will W3 and W4.

Horizontal shoulder surfaces 33 may be from 0 degree horizontal to 45 degrees. The length of downward-sloping surfaces 32 may also be adjusted to fit design parameters, and may in some cases by completely vertical—eliminating features 33 and 34 on one side only. The total height between upper/top surface 31 and base 37 will vary depending on tire size and placement on casing.

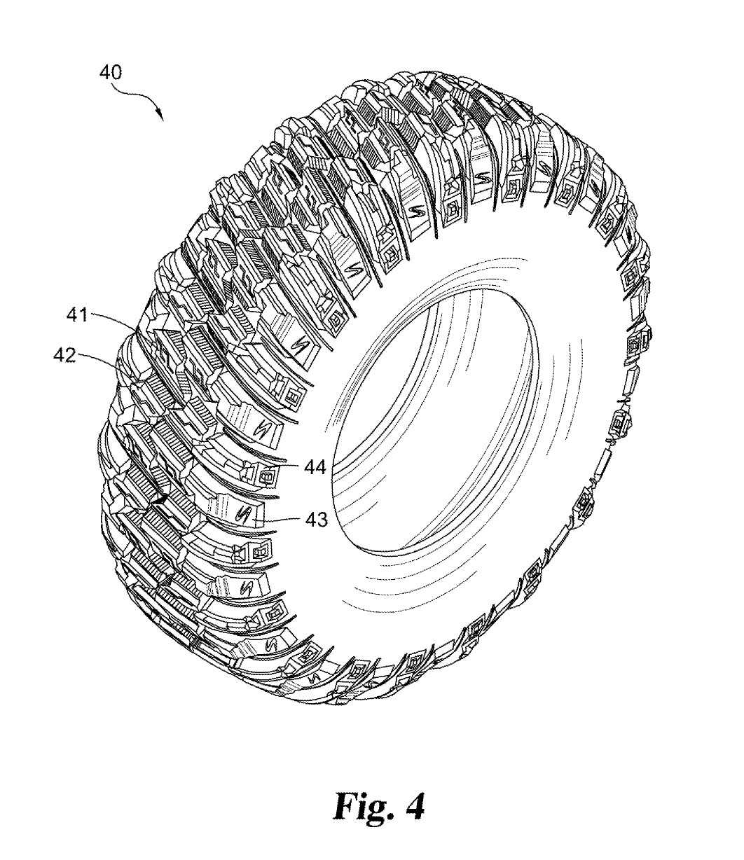

FIG. 4 shows a perspective view of a vehicle tire according to one embodiment of the present invention. Tire 40 comprises a multiplicity of central tire tread blocks, including first central tread blocks 41 and second central tread blocks 42. In the illustrated embodiment the central tread blocks consist essentially of an approximately equal number of first central tread blocks 41 and second central tread blocks 42. Tire 40 also comprises a multiplicity of sidewall tread blocks, including first sidewall tread blocks 43 and second sidewall tread blocks 44. In the illustrated embodiment the sidewall tread blocks consist essentially of an approximately equal number of first sidewall tread blocks 43 and second sidewall tread blocks 44.

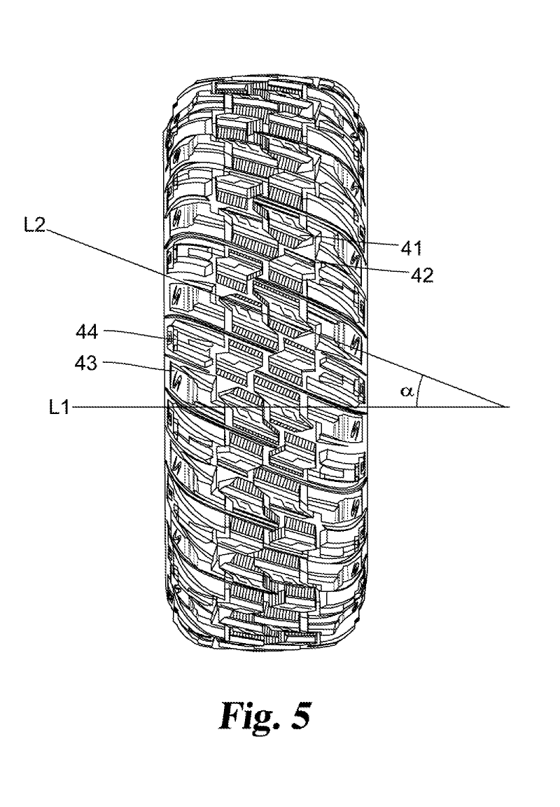

FIG. 5 shows a front view of a vehicle tire according to one embodiment of the present invention. In this view, first central tread blocks 41, second central tread blocks 42, first sidewall tread blocks 43, and second sidewall tread blocks 44 are illustrated.

Central tread blocks 41 and 42 are arranged so that they are angled with respect to the direction of travel of the tire. In particular, first central tread blocks 41 and second central tread blocks 42 are positioned such that the leading and/or trailing edges of the blocks (which are preferably parallel to each other) are angled at a 20-25° angle between the tread bloc edge and a line perpendicular to the direction of roll.

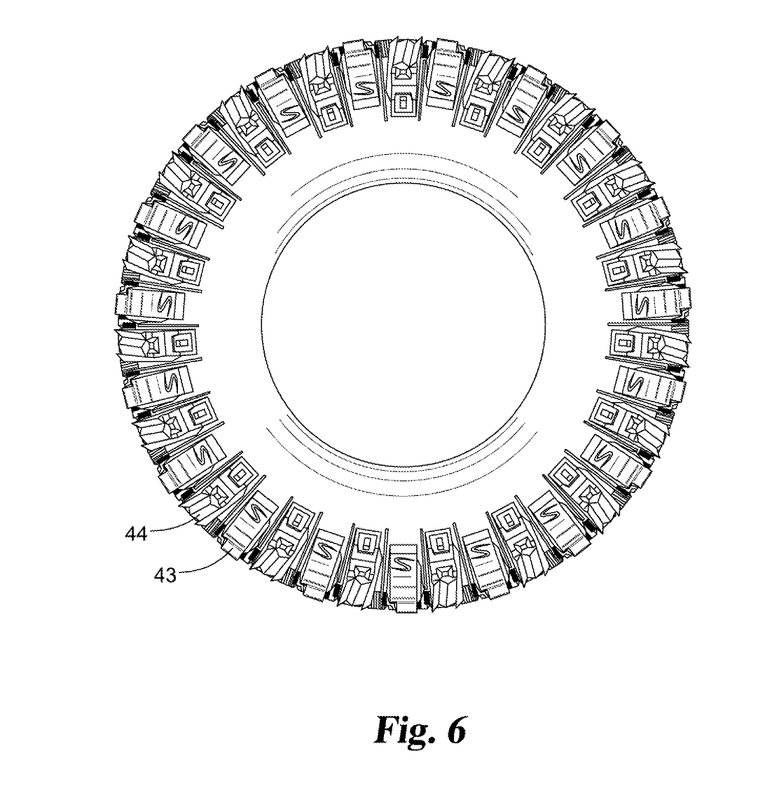

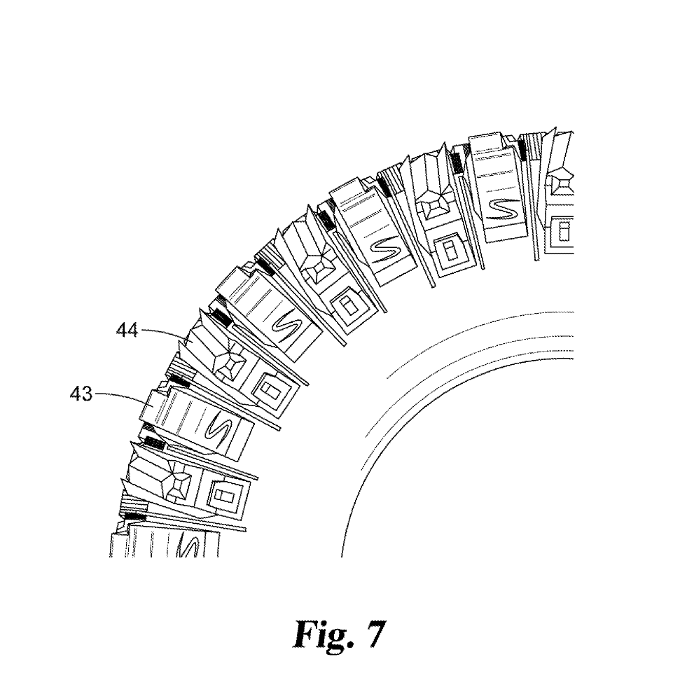

FIG. 6 and show side views of a vehicle tire according to one embodiment of the present invention. Sidewall tread blocks 43, and sidewall tread blocks 44 can clearly be seen in these views.

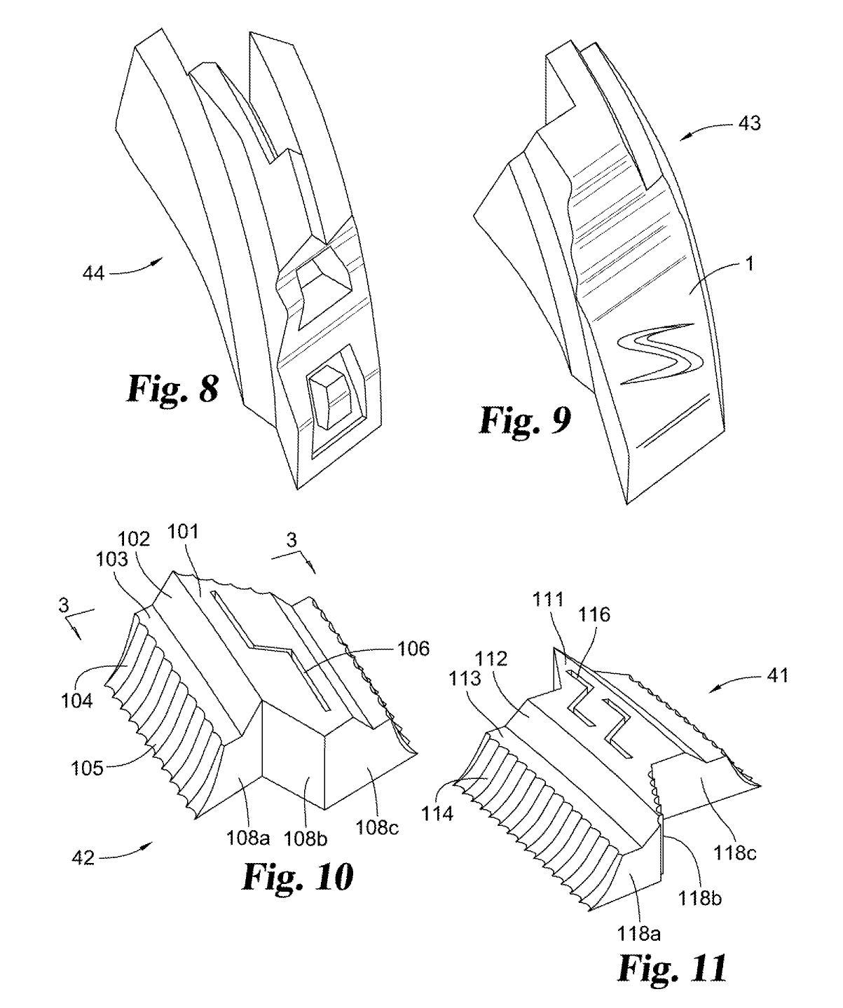

FIG. 8 shows perspective views of sidewall block 44, showing greater detail of the various portions of the block.

FIG. 9 shows a perspective view of a sidewall block 43, showing greater detail of the various portions of the block.

FIG. 10 shows a perspective view of tread block 42 having a cross-section substantially the same as the tread block cross section as shown by FIG. 3. FIG. 10 shows the substantially-horizontal upper/top surface 101, the first pair of downward-sloping surfaces 102 that slope downward and outward from upper/top surface 101, the pair of horizontal shoulder surfaces 103, and the second pair of downward-sloping surfaces 104 that slope downward and outward from horizontal shoulder surfaces 103. In the illustrated embodiment downward-sloping surfaces 104 include scallops 105 and siping 106.

The leading and trailing faces (comprising the first pair of downward-sloping surfaces 102, the two horizontal shoulder surfaces 103, and the second pair of downward-sloping surfaces 104) of the tire block shown in FIG. 10 are free from any “vertical” surfaces (i.e., free from surfaces that are at a 90° angle with respect to the base of the tire block). The two side faces (comprising face portions 108a, 108b, and 108c, and the corresponding faces on the opposite side of the tread block) are substantially vertical with respect to the base of the tire block. Surfaces 101 and 103 are parallel to the base of the tire block, and surfaces 102 and 104 are angles at an angle of less than 90° with respect to the base of the tire block.

FIG. 11 shows a perspective view of another tread block 41 having a cross-section substantially the same as the tread block cross section as shown by FIG. 3. FIG. 11 shows a substantially-horizontal upper/top surface 111, the first pair of downward-sloping surfaces 112 that slope downward and outward from upper/top surface 111, the pair of horizontal shoulder surfaces 113, and the second pair of downward-sloping surfaces 114 that slope downward and outward from horizontal shoulder surfaces 113. In the illustrated embodiment downward-sloping surfaces 114 include scallops 115 and sipings 116.

As with the tire block of FIG. 10, the leading and trailing faces (comprising the first pair of downward-sloping surfaces 112, the two horizontal shoulder surfaces 113, and the second pair of downward-sloping surfaces 114) of the tire block shown in FIG. 11 are free from any “vertical” surfaces (i.e., free from surfaces that are at a 90° angle with respect to the base of the tire block). The two side faces (comprising face portions 118a, 118b, and 118c, and the corresponding faces on the opposite side of the tread block) are substantially vertical with respect to the base of the tire block. Surfaces 111 and 113 are parallel to the base of the tire block, and surfaces 112 and 114 are angles at an angle of less than 90° with respect to the base of the tire block.

In view of the above, it can be seen that off-highway tires need to be flexible and conformable to operate properly. Low air pressure is typically used to allow these properties to operate. With the advent of much higher horsepower vehicles now and looming in the future, casing distortion caused by high torque loads tires generally will see a decrease in tread void. This current practice decreases contact pressure necessary for optimum off highway performance. The “Inca pyramid” shape of the tread blocks of the present invention allows for high contact pressure by having transissional torque spread over a much larger area of casing controlling tread distortion.

In addition, off-highway floatation, traction and less soil disturbance is also enhanced. Normal straight or slightly tapered tread elements have a tendency to break soft surfaces and scoop large amounts of soil causing rutting. The high tapered design of the inventive “Inca” pyramid design digs down slightly and compresses the soil between the tread elements, thus minimizing digging and rutting while providing traction as the compacted soil now reacts like a much harder, more stable surface.

Further, off-highway mud and show performance is improved. The angle of each tread element coupled with seriated lower section allows snow to be momentarily trapped and locked into the tread surface. Snow tires perform by creating snow to snow contact then ejecting the once trapped snow to gain a new fresh “bite.” In mud a high tapper is necessary so sticky mud can be ejected. now the seriated lower edges work with suction release ribs (mud release) at the base of each tread element to allow air to work up and around mud compacted in between tread elements. These three features, seriated lower tread block, high taper and suction release ribs allow the inventive tire to perform very near to a straight mud tire.

Also, highway performance is improved. The more stable the tread elements, the more solid and precise directional stability will be, along with great responsiveness at low recommended air pressures.

Finally, tread life is improved. As the tread elements are stable and resist tread compression and distortion additional tread life should be realized.

While the invention has been illustrated and described in detail in the drawings and foregoing description, the same is to be considered as illustrative and not restrictive in character, it being understood that only certain preferred embodiments have been shown and described, and that all changes and modifications that come within the spirit of the invention are desired to be protected.

Additionally, it is to be appreciated that the present invention may comprise or consist essentially of any or all of the described or illustrated elements. Further, any or all of the features, elements, and/or embodiments disclosed herein may be combined with any or all of the other features, elements, and/or embodiments disclosed herein to provide an invention that comprises or consists essentially of such features, elements, and/or embodiments.

The grammatical device “and/or” (such as in “A and/or B”) is used in this disclosure to mean A alone, or B alone, or both A and B.

1. A vehicle tire, comprising:
a) a first/lower body ply;
b) a first stabilizing belt directly overlaying the first/lower body ply and having cords running in a first direction;
c) a second/upper stabilizing belt overlaying the first stabilizing belt and having cords running in a second direction that is different from the direction of the first stabilizing belt;
d) a second/upper body ply; and
e) an outer tread layer;
wherein said outer tread layer comprises a multiplicity of tread blocks providing a tread pattern, wherein said multiplicity of tread blocks comprises a multiplicity of first central tread blocks, and a multiplicity of sidewall tread blocks; and
wherein each of said first central tread blocks comprises:
a) a substantially-horizontal upper/top surface;
b) a first pair of downward-sloping surfaces sloping downward and outward from the upper/top surface;
c) a pair of horizontal shoulder surfaces, wherein each of said pair of horizontal shoulder surfaces extends outward from one of said first pair of downward-sloping surfaces, and
d) a second pair of downward-sloping surfaces sloping downward and outward from the horizontal shoulder surfaces.

2. A tire according to claim 1 wherein said first/lower body ply has a radial ply construction.

3. A tire according to claim 1 wherein said first/lower body ply has a bias ply construction.

4. A tire according to claim 1 wherein said first stabilizing belt comprises a network of natural or artificial fibers.

5. A tire according to claim 1 wherein said first stabilizing belt comprises a para-aramid synthetic fiber.

6. A tire according to claim 1 wherein said second body ply has a radial ply construction.

7. A tire according to claim 1 wherein said second body ply has a bias ply construction.

8. A tire according to claim 1 wherein said second stabilizing belt comprises a network of natural or artificial fibers

9. A tire according to claim 1 wherein said second stabilizing belt comprises a para-aramid synthetic fiber.

10. A tire according to claim 1 wherein:
a) said a first/lower body ply comprises a first radial body ply;
b) said first stabilizing belt comprises a first bias ply made of a para-aramid synthetic fiber;
c) said second stabilizing belt comprises a second bias ply made of a para-aramid synthetic fiber; and
d) said second body ply comprises a second radial body ply.

11. A tire according to claim 1 wherein at least some of said tread blocks have one or more scalloped surfaces on said tread block.

12. A tire according to claim 1 wherein at least some of said tread blocks have Z-shaped grooves or sipings in said tread blocks.

13. A tire according to claim 1 wherein at least some of said tread blocks have mud release ribs.

14. A tire according to claim 1 wherein at least some of said tread blocks have sidewall deflection ribs.

15. A tire according to claim 1 wherein at least some of said tread blocks are positioned such that there is a 20-25° angle between the leading edge of the tread block and a line perpendicular to the direction of roll.
